(19) United States
(12) Patent Application Publication
(10) Pub. No.: US 2025/0003568 A1
(43) Pub. Date: Jan. 2, 2025

(54) IMAGE EMITTING DEVICE

(71) Applicant: Charles C. Hanlon, Bitely, MI (US)

(72) Inventor: Charles C. Hanlon, Bitely, MI (US)

(21) Appl. No.: 18/756,446

(22) Filed: Jun. 27, 2024

Related U.S. Application Data
(60) Provisional application No. 63/524,072, filed on Jun. 29, 2023.

(51) Int. Cl. F21S 43/50

(52) U.S. Cl. CPC F21S 43/50; F21S 43/265

(57) ABSTRACT

An image emitting device for use with a vehicle includes a plate with a plurality of regions arranged in a pattern to form an image, with the plate having a first side forming a light emitting side and a second side forming a light input side. A light source directs light into the light input side of the plate when powered, which is powered by a power circuit to selectively power the light source based on (1) user input or (2) based on proximity to another image emitting device. In one form the regions comprise openings through the plate.

### CROSS REFERENCE TO RELATED APPLICATION

The present application claims priority of U.S. provisional application Ser. No. 63/524,072 filed Jun. 29, 2023, which is incorporated by reference herein in its entirety.

### TECHNICAL FIELD AND BACKGROUND

In today's automotive and aftermarket parts arena, manufacturers are finding it difficult to catch the attention of vehicle and aftermarket part buyers. Innovation has slowed and creativity has lagged behind the consumer's demand for personalization, uniqueness, and social contact with their vehicles, while driving. Manufactures are limited in the customizing of vehicle packages with creative and socially interactive features. Likewise, aftermarket manufactures, although more progressive, lack the insight and coordination to deliver on inventions which will get their customers noticed and create that social bond and uniqueness the consumer desires. Vehicle lighting or the installation of sticker symbols seem to be of interest to many consumers and fills some gaps in consumer demands for individuality of their vehicle, which garners attention.

### SUMMARY

An image emitting device proposed herein provides a means to acknowledge social contacts via lighting a changeable image while operating a vehicle or while the vehicle is stationery.

As described herein, in one embodiment, an image emitting device mounts externally to a vehicle, illuminates on demand, and displays a masked unique identifier or image(s). The image emitting device provides vehicle operators of a common social or cultural interest with the ability to acknowledge each other from their vehicles while operating or stationary.

Multiple embodiments of the image emitting device are available. For example, in one embodiment, the image emitting device can show more than one image, including a vehicle brand, team logo, alma mater, etc. and other images, such as trademarks. The image emitting device is mounted so that it does not restrict the operator's field of view through the windshield. For example, the image emitting device may be mounted to the exterior of a vehicle with a multi tension snap arrangement that extends over a mirror casing or a bolt-on design.

In other aspects, the image emitting device may have a low lumen colored LED light output, so it creates social notoriety but does not distract drivers.

In one embodiment, the image emitting device may have remote control device activation, such as wireless key fob activation, physical or proximity-based activation via a phone application when near a social contact, and also may offer multiple illumination options, such as timed on, flashing on, on/off, or hold on.

In other embodiments, the image emitting device may have internal waterproof wiring and may receive power from replaceable batteries or the vehicle.

In some embodiments, the image emitting device has a device housing that may be contoured to follow the contour of an OEM exterior side view mirror housing.

In other applications, the image emitting device can be mounted with bracketry to other areas of the vehicle including the A pillar or grill, etc.

As will be more fully described below, an image emitting device that emits an image is provided that can be mounted to an exterior surface of a vehicle, such as an exterior side view mirror assembly, an A-pillar, or a front grate, or the like. The image emitting device is mounted so that the image is emitted forward through the forward-facing side of the device but with the image remaining hidden or concealed until activation. The device can be driver activated manually (e.g., via a key fob, phone application or other technologies) or activation can be based on proximity to other image emitting devices. Multiple embodiments offer different levels of functionality.

In some embodiments, the image emitting device may be formed as an exterior side view mirror cover or may be integrated into an exterior side view mirror casing. In either case, the image emitting device is mounted or formed so that it faces toward the front of the vehicle where it will transmit the image forward when activated.

In some embodiments, the image emitting device may have its own power source, such as a battery pack or may be connected to vehicle power.

In some embodiments, the image emitting device may manually, or in an automated fashion, illuminate the image on the front of the mirror casing via a switch, remote, wireless technology, app, voice command, remote sensor, etc. in order to signify or identify the gesture from the front or forward-facing position of the mirror housing toward an oncoming like vehicle.

In some embodiments, the image emitting device may an add-on component, module or assembly, replacement component, module or assembly, an original equipment component, module or assembly in whole or in part by which an illuminated or lit image, symbol, sign, gesture or identifier can be demonstrated or displayed to likeminded vehicle owners.

The above advantages, purposes and other features of the invention will become apparent from a study of the prior and following detailed description taken in conjunction with the appended drawing featured below.

### BRIEF DESCRIPTION OF DRAWINGS

FIG. 1A is an isometric view of an image emitting device with a symbolic backlit image and a remote control device;

FIG. 1B is an isometric view of the image emitting device of FIG. 1A mounted to a mirror casing of an exterior side view mirror assembly;

FIG. 2 is a rear isometric view of the image emitting device and controller of FIG. 1A;

FIG. 3 is an exploded view of the image emitting device of FIG. 1A;

FIG. 4 is a schematic diagram of a control circuit;

FIG. 5 is a schematic diagram of another embodiment of a control circuit;

FIG. 6 is an isometric view of another embodiment of the image emitting device attached to a mirror casing of an exterior side view mirror assembly;

FIG. 7 is an isometric view of a third embodiment of the image emitting device formed in an exterior side view assembly mirror casing;

FIG. 8 is an isometric view of a fourth embodiment of the image emitting device attached to a mirror casing of an exterior side view mirror assembly;

FIG. 9 is an enlarged elevation view of an image plate of the image emitting devices of FIGS. 1A, 3, and 6-9;

FIG. 10 is an enlarged elevation view of another embodiment of the image plate of the image emitting devices of FIGS. 1A, 3, and 6-9;

FIG. 11 is an enlarged elevation view of a third embodiment of the image plate of the image emitting devices of FIGS. 1A, 3, and 6-9;

FIG. 12 is an enlarged elevation view of a fourth embodiment of the image plate of the image emitting devices of FIGS. 1A, 3, and 6-9; and

FIG. 13 is an enlarged elevation view of a fourth embodiment of the image plate of the image emitting devices of FIGS. 1A, 3, and 6-9; and

FIG. 14 is a flow chart describing the functionality of an application that configures the light control circuit according to individual user preferences.

### DETAILED DESCRIPTION

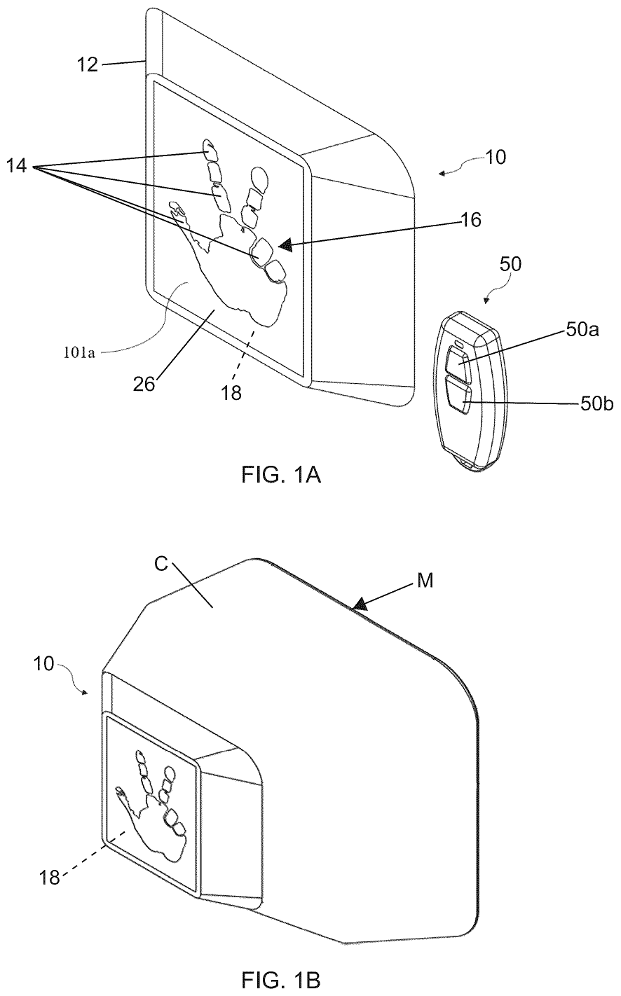

Referring to FIG. 1A, the numeral 10 generally designates one embodiment of an image emitting device for use with or incorporated into an exterior of a vehicle. The term “vehicle” is used broadly to include any and all vehicles, including automotive vehicles, such as cars, trucks, RV's, as well as marine vehicles, such as boats and personal watercrafts and others. As will be more fully described below, in some embodiments, the image emitting device is configured to mount to the mirror casing of a side view mirror assembly (FIG. 1B). In other embodiments, the image emitting device may be formed with the mirror casing (FIG. 7). In yet other embodiments, the image emitting device is configured to mount to an A-pillar of the vehicle or to the front grill of the vehicle. In all the embodiments, the image emitting device generates an image—not just a signal light—to acknowledge or communicate with an oncoming vehicle and not to indicate a turning direction. To that end the light output by the images described herein is less than the U.S. standards for lumens for a signal light and also do not produce an amber frequency color to avoid confusion with a turn signal.

Further, the image emitting device may be configured to have two states-one state where the image is visible and the other state where the image is not visible so as not detract from the vehicle's aesthetics. Therefore, the image only appears when the driver activates the image emitting device, or in some embodiments when the image emitting device automatically is activated.

In other embodiments, the image may be colored to match the color of the image plate, e.g., black on a black plate, so the image outline cannot be seen when the light source is not actuated but is visible when the light source is actuated and the image is illuminated.

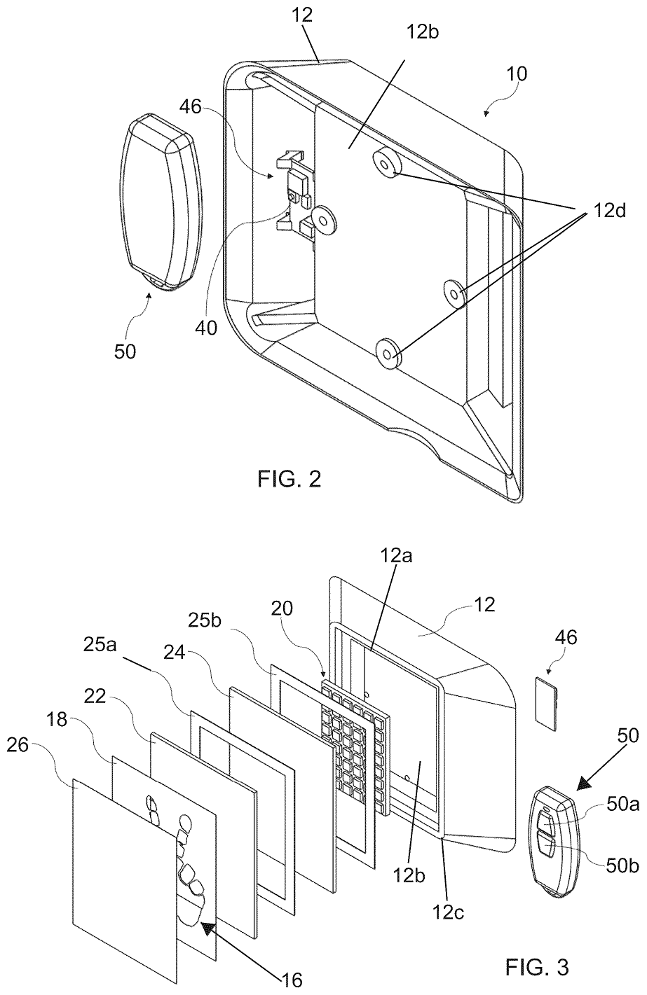

As best seen in FIGS. 1A and 2, in one embodiment, image emitting device 10 includes a device housing 12 with one or more light transmitting regions 14 that when illuminated form a shape or image 16 that is activated to convey a message. Light transmitting regions 14 may be formed from openings or transparent or semitransparent regions and are illuminated by one or more lights (described below) located with the device housing 12.

The device housing 12 may be constructed from any number of materials commonly known, used and commonly seen in automotive side mirror housings. These may include plastics, such as ABS, Polypropylene, Polycarbonate, Acrylic, PVC, etc. or other plastics, including reinforced plastics, such as reinforced with fibers, including carbon fibers, glass fibers, etc., or other fiber products or metals. For example, device housing 12 may be formed by vacuum molding, 3D printing, injection molding, blow molding, stamping, or pressing.

The device housing 12 may be formed with mounting structures, such as mounting bosses, to allow the device housing to be mounted to the exterior surface of the vehicle, such as noted above, using fasteners, such as screws or bayonet structures that provide a snap fit coupling to receiving structures formed on the exterior surface, such as recesses or through holes. In one embodiment (FIG. 1B), device housing 12 is mounted to a mirror casing C of an exterior side mirror assembly M. Further, device housing 12 is mounted to forward facing side of the mirror casing C and may have a footprint that is less than the forward-facing side of the mirror casing C. In this manner, the image emitting device 10 does not restrict the vehicle operator's field of view. In other embodiments, device housing 12 may have a footprint that is approximately equal to the forward-facing side of the mirror casing so it appears to form the mirror casing and, optionally, can cover the entire mirror casing.

Alternately, the device housing may be formed with rails to engage channels provided or formed on the exterior surface of the vehicle. In another embodiment, the device housing may be mounted using magnets that are supported in the device housing and that couple to magnetic structures, such as ferromagnetic plates, or magnets mounted at the exterior surface of the vehicle. In yet other embodiments, the device housing 12 may be attached the exterior surface of the vehicle via an adhesive or one or more mounting brackets.

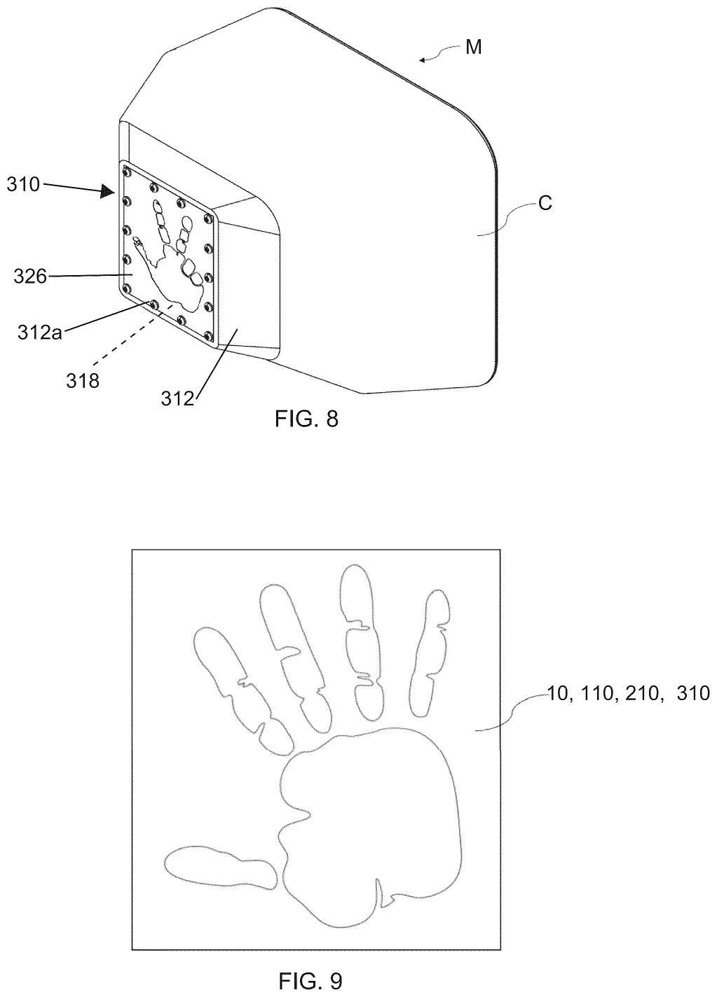

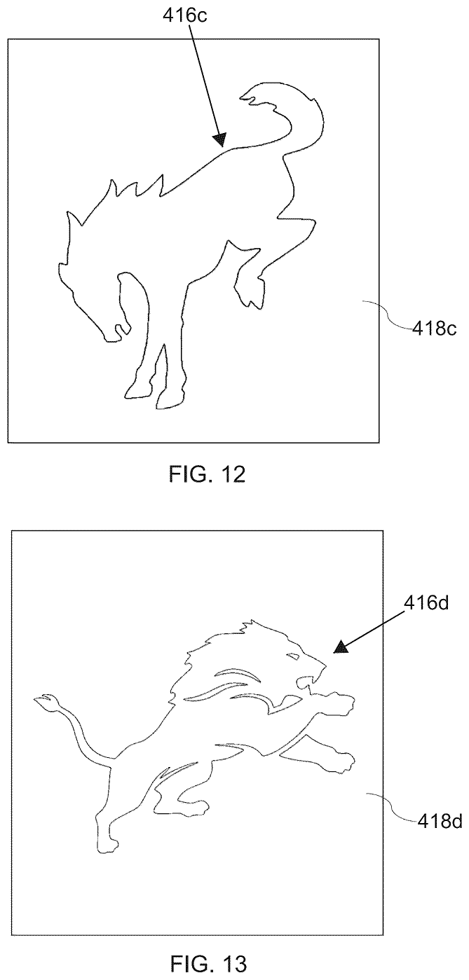

Referring again to FIG. 3, in the illustrated embodiment, the regions 14 are formed in an image plate 18 that is mounted in an opening 12a in device housing 12. For example, the image plate 18 may comprise a metal or plastic plate (see examples of materials above described in reference to the housing 12) with the regions 14 (and hence image 16) formed in the plate 18 using a CNC machine or similar process and/or machine in order to create the regions (e.g., openings or thinned walled regions) that form the image. Optionally, as will be described in reference to FIGS. 3 and 9-12, image plate 18 may be removable for replacement.

Alternately, the regions may be formed on a film that is applied to the image plate 18. The film may have regions with high opacity and low or no opacity with the regions with low opacity or no opacity being configured to form the image.

Referring again to FIG. 3, image emitting device 10 also includes a light source 20, such as one or more LEDS (strip, rope, or an LED array or matrix), EL (Electroluminescent Lighting), HID (high intensity discharge light), halogen, incandescent, or the like. Light source 20 may be integrated or coupled to a circuit board 38 with a power circuit 40, as described below, or to a controller, or electrically connected to the vehicle control system.

In one embodiment, light source 20 produces a low lumen light, such as lumens less than the minimum lumens required by code for headlights, for example, less than 500 lumens, or less than the minimum lumens required by code for signal lights. Additionally, the color of the light source may vary but does not include amber color frequencies associated with turn signals.

Optionally, circuit board 38 or power circuit 40 may include a timer circuit wherein the light source 20 is powered by the power circuit 40 for a predetermined or a selected duration of time.

In one embodiment, the light source 20 may comprise a display screen, such as an LCD screen, with the image (or images) formed on the screen instead of the regions 14 of plate 18. Instead, a single region may be formed in plate 18, with the image or images projected onto the region by the screen. Images, therefore, may be changed and may be uploaded to the memory of the controller described below. Further, image emitting device may, therefore, emit more than one image.

Positioned between light source 20 and image plate 18 may be one or more diffusers 22, 24, such as plates formed from Makrolon DX, which diffuse the light to produce a more even distribution of the light across the image. Further, the image plate 18 may be protected by a cover 26, which is mounted to or over plate 18. The cover 26 may be formed from a transparent material suitable to form a rigid lens, such as plastic or glass, or may be formed from a flexible film. In addition, the cover 26 may be configured to mask the image. For example, the cover may reduce the transmissivity in the regions to a transmissivity in a range anywhere from 0% to 100%, or from 10% to 50%. In the case, therefore, where the image is formed by a film over plate 18, the cover 26 may be formed by a second film over the image producing film, which masks the image.

For example, when rigid, the cover 26 may be formed from a lamination with an internal layer of an electrochromic material that when activated darkens to hide the image. When deactivated, the electrochromic layer allows light transmission therethrough. The activation, therefore, could be controlled by the activation signals that generate power to the light source.

Alternately, when cover 26 is formed from a film, the film may be selected so that it masks the image until the light source is energized. For example, the film may be formed from an translucent film, such as Luxe Gloss Smoke Tint with VLT between 10-40 and 3.5 mils thick, which is applied over image plate 18 (or over the image forming film) and which renders the image 16 not viewable or it is obscured when the power to the light source 20 is not activated. In another embodiment, when the cover 26 forms a lens, the lens may be configured to hide the image when view from the side but allow viewing of the image at least when looking at the image emitting device 10 from a viewing angle that is generally orthogonal to the image plate.

In addition to diffusers 22 and 24, image emitting device 10 may include adhesive seals 25a, 25b between diffusers 22 and 24 and between diffuser 24 and an inner wall 12b of device housing 12 (FIG. 3). Optionally, seals 25a, 25b may comprise waterproof adhesive seals available from 3M under the name VBH 5909. Thus, as understood from FIG. 3, cover 26, plate 18, diffusers 22 and 24, seals 25a, 25b, as well as light source 20, may be arranged in a stacked arrangement, which is then mounted to inner wall 12b (FIG. 3), which is formed or provided in device housing 12. Light source may be potted against the inner wall 12b, using a sealant.

Optionally, the stacked arrangement may be secured in place by a bezel 12c or cover 26 which may be mounted in opening 12a and/or on a shoulder formed and recessed in opening 12a, for example, by fasteners or an adhesive.

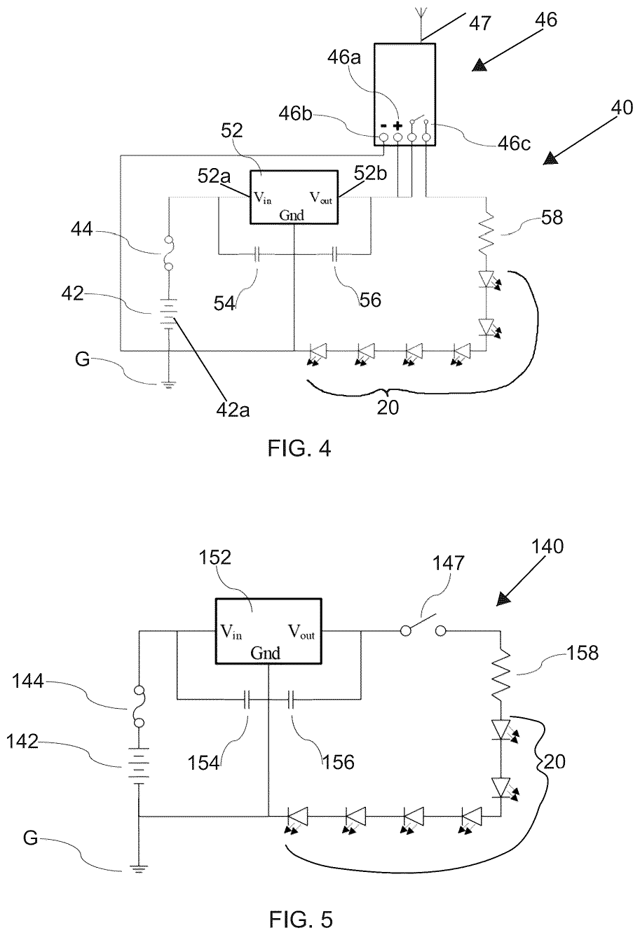

As noted above, image emitting device 10 may be self-contained and include a power circuit 40 and a power source 42, such as a battery 42a, to power light source 20. Details of the wiring are omitted from FIG. 3 for clarity, and instead reference is made to FIG. 4. The power circuit 40 may be mounted to a circuit board, which is then mounted in device housing 12 on mounting structures formed or otherwise provided in device housing 12. The battery 42a may be connected to a chassis ground G on its negative terminal, and a current limiting fuse 44 is connected to its positive terminal to supply unregulated power to the light source 20.

Power circuit 40 may also include a controller 46 with a user actuatable input 47 that allows a user to activate the power circuit 40 to power the light source 20. The term “controller” is used broadly to include a microprocessor-based controller, and memory, for processing instructions or for processing an algorithm stored in memory to control operation of the light sources. The controller may comprise one or more microcontrollers, field programmable gate arrays, systems on a chip, discrete circuitry, and/or other suitable hardware, software, or firmware that is capable of carrying out the functions described.

In the illustrated embodiment, input 47 may comprise a receiver (such as an RF receiver, including a Bluetooth receiver) that receives input signals from a remote control device 50 (FIGS. 1A and 3), such as a handheld device, with a transmitter (such as an RF transmitter, including a Bluetooth transmitter) that generates an input signal to receiver 47 when user activates a user input 50a on remote control device 50, such as a button. The terms “receiver” and “transmitter” are used broadly herein and may include software and/or hardware to enable the functions described herein.

Optionally, user unput 50a may be a two-position button (on or off) of the remote control device 50, which may also include a second user input 50b, such as a second button, which provides the off function. Thus, once an on or activation signal is generated by remote control device 50, power that is supplied to the controller 46 from power source 42 via the positive terminal 46a (and when the negative terminal 46b is connect to chassis ground G) is output by controller 46 at its output connection (e.g., output switch) 46c to power light source 20. The signals from buttons 50a, 50b may be interpreted by the controller 46 differently depending on the programming features saved in the controller 46 and may be selected by one or both of the buttons 50a, 50b. For example, time delays, latching characteristics, and other programming features may be applied by controller 46 to the RF output connection 46c to control the performance of image emitting device 10.

To regulate the voltage in power circuit 40, power circuit 40 may include a voltage regulator 52. Voltage regulator 52 receives unregulated power on its Vin terminal 52a and outputs regulated voltage on its Vout terminal 52b. A capacitor 54 may be connected between the Vin terminal 52a of voltage regulator 52 and the ground terminal of the voltage regulator to stabilize the voltage regulator 52 from oscillation. A second capacitor 56 may be connected between the Vout terminal 52b of the voltage regulator 52 and the ground terminal of the voltage regulator to improve transient response of the voltage regulator 52.

Further, power circuit 40 may include a current limiting resistor 58 connecting output connection 46c to light source 20 to limit the amount of current flowing through the light source, such as the LED light array as noted, to the chassis ground G.

Referring to FIG. 5, in an alternate embodiment of power circuit 140, rather than having a receiver, power circuit 140 may include another user actuatable input 147, such a switch. Power circuit 140 may also omit the controller and instead have a simplified power circuit. The user actuatable input 147 may be mounted inside the vehicle, such as at the dashboard. In this embodiment, user actuatable input 147 may have a binary state-on or off. Similar to the previous embodiment, when user actuatable input 147 is closed and, hence moved to its on position, power that is supplied to the switch from power source 142 via a first terminal 146a of the switch is passed through the switch to power light source 20.

Similar to the previous embodiment, to regulate the voltage in power circuit 140, power circuit 140 may include a voltage regulator 152. Voltage regulator 152 receives unregulated power on its Vin terminal and outputs regulated voltage on its Vout terminal. A capacitor 154 may be connected between the Vin terminal of voltage regulator 152 and the ground terminal of the voltage regulator to stabilize the voltage regulator 152 from oscillation. A second capacitor 156 may be connected between the Vout terminal of the voltage regulator 152 and the ground terminal of the voltage regulator 152 to improve transient response of the voltage regulator 152.

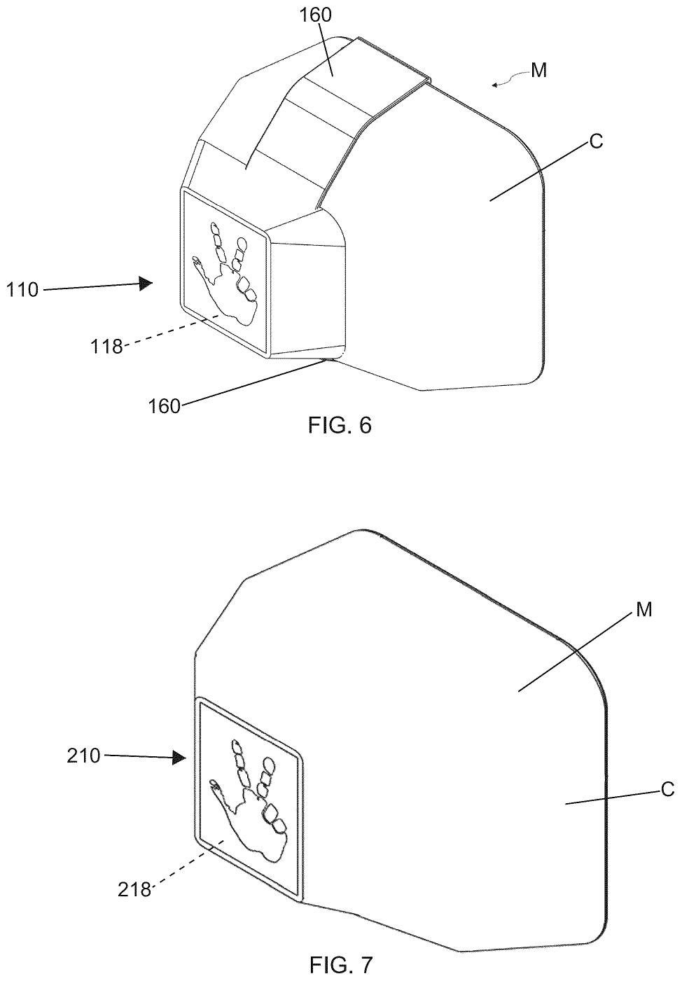

Referring to FIGS. 6-9, as noted above, alternate embodiments of image emitting device 110, 210, 310 may be configured with different mounting arrangements or may be integrated with the mirror casing. As best seen in FIG. 6, image emitting device 110 may include one or more mounting structures 160. For example, mounting structures 160 may comprise elongated planar arms that extend from the device housing 112 and extend outside the footprint of the device housing 112. For example, the upper arm may extend over the top of mirror casing C to engage, for example, the upper rearwardly facing edge of mirror casing C (e.g., along rearwardly facing opening of mirror casing C). The other arm may extend under mirror casing C to engage, for example, the lower rearwardly facing edge of mirror casing C (e.g., along rearwardly facing opening of mirror casing C).

For example, the mounting arms may be formed so they are dimensionally smaller than the mirror casing so that they can form a snap fit connection with the mirror casing so that the image emitting device may be mounted without the need for fasteners. Further, the distal ends of the arms may be formed with lips or recesses to engage the top and bottom edges of the mirror casing or the top and bottom edges of the rearward facing opening of the mirror casing, as noted above. For other details not mentioned herein of image emitting device 110, for example, the internal components, reference is made to image emitting device 10.

Referring to FIG. 7, image emitting device 210 may be integrally formed with mirror casing C so that at least the image plate, the light source and the power circuit are housed in mirror casing C. For other details not mentioned herein of image emitting device 210, for example, the other internal components, reference is made to image emitting device 10.

Referring to FIG. 8, similar to image emitting device 10, image emitting device 310 may form a self-contained module. In the illustrated embodiment, plate 318 of image emitting device 310 is mounted to device housing 312 by a plurality of fasteners 312, such as screws or bolts, that extend through the forward-facing side of plate 318 and into corresponding mounting openings formed in an internal wall (similar to wall 12b) of the device housing 312 or to mounting bosses formed inside device housing 312. For other details not mentioned herein of image emitting device 310, for example, the other internal components, reference is made to image emitting device 10.

As noted above, any of image plates 18, 118, 218, and 318 may be removably mounted in their respective image emitting devices 10, 10, 210, and 310. The attachment method may or may not include fasteners (integrated or not). Suitable fasteners may include clips, snaps, tabs, etc. for optional removable securement of the image plates in the respective device housing. The image plates 18, 118, 218, and 318 may be removed for repair or replacement so that a user may customized the image to their needs. Alternately, any of image plates 18, 118, 218, and 318 may be permanently mounted during the forming process, e.g., via an adhesive or welded in place or snap fit in place when the mirror casing is still uncured and somewhat flexible, with the customization of the image being performed when the image emitting device is manufactured.

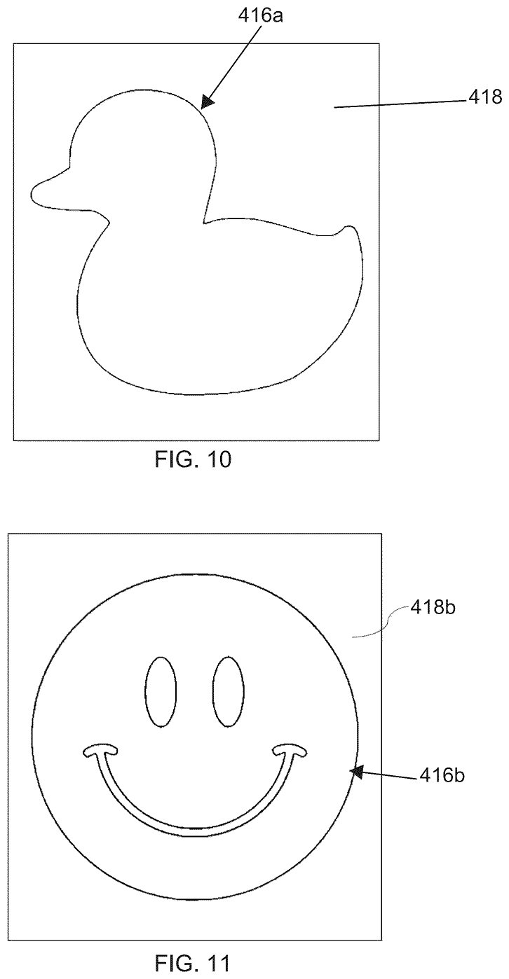

Referring to FIGS. 10-13, replacement image plates 418a, 418b, 418c, 418d may have alternate images 416a, 416b, 416c, and 416d, for example. Images 16 and 416a-416d are exemplary only and not intend to limit the scope or type of images.

As described above, any of device housings 12, 112, and 312 may house an image plate, diffusers, a light source, a power circuit, a power supply, and optionally a controller and a receiver.

To accommodate the various internal components, each device housing, therefore, may be formed with a space behind the respective image plate that is sufficient to house the light or lights, control circuitry, and battery described above. Optionally, the space may be relatively small so that the image emitting device may have a slim profile. For example, the thickness (depth of the device housing as measured from the face of the image plate to the mounting surface of the device housing) may be in 0.25 inches to 4.5 inches thick.

As would be understood, the device housings described herein (12, 112, 312) may be formed in a single molding step or may be formed in a multistep process. For example, the space behind the image plate (for receiving, for example, the light source, control circuitry, controller, and battery) may be formed via a second step molding or, as noted, originally formed as a one-step manufacturing process. Many polymeric bodies or housings are formed by injection molding or 3D printing, etc. a polymer material into the center or core of the injection molding mold. Any of the device housings may include a core, tabs, attachments, holes, pins, etc. integrated into the housing. The polymer once cool creates a hard item which can be altered to be accepting of the illumination, shielding, wiring or controls.

As noted above, the images may be formed from openings in the image plates or by regions of reduced thickness. Further, as noted they may be covered with a cover, including a film, so that the images may be colored or smoked via the plate or cover material. Alternately, the color of the images may be controlled by the color of the light source, which may vary and further may be varied by the user. For example, when the light source is formed from LEDs, the LEDs may be adjustable to vary the color of the light output by the respective LEDs. Alternately, the LEDs may include RGB LEDs that are independently controlled to vary the color of the light output by the light source.

Further, image emitting devices 10, 110, 210, and 310 may be weatherproof or weather resistant. For example, seals may be 3M VHB 5909 Bezel Tape.

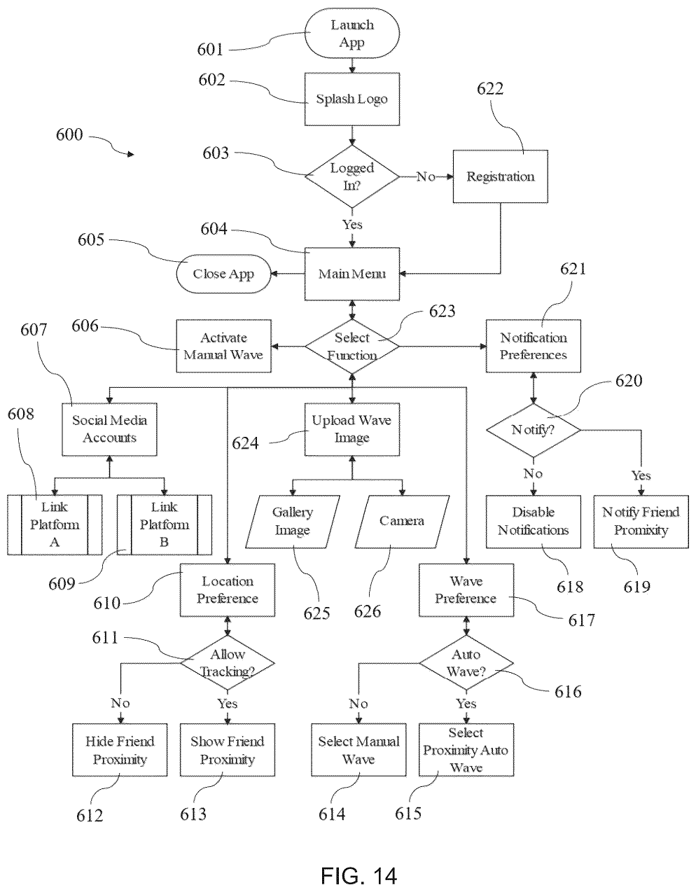

As noted, image emitting devices 10, 110, 210, and 310 may be controlled by a switch mounted in the vehicle or by a remote control device, including Bluetooth device, or a proximity sensor, or by voice activation, or by an app for a smart phone, as described below in reference to FIG. 14.

Further, the light source may generate a strobe, stable or changeable solid color light or have changing/chasing color modes, including neon colors. The illumination may also be synchronized to music.

In any of the module forms of the image emitting devices (10, 110, and 310), the image emitting device may include a wiring kit with installation instructions.

Referring to FIG. 14, the numeral 600 generally designates an application (“App”) that may be stored on a remote control device, such as a handheld device, including a phone or tablet. App 600 is first launched (601) by a user by selecting an icon on the remote control device. When launched, an App logo pops up (602) and then a log-in-page (603). If a user is registered, then App goes straight to a main menu (604).

If a user is not registered, the App will generate a registration input page (622) where the user provides identifying information to register as a user. Once registration is completed a user is logged in and moved to the main menu (604).

At the main menu, the user can close the application (605), or they can select one of the App functions (623). The menu may have one or more functions and provide a select function button (623) to select between the functions. For example, one function includes an on-off button (e.g., button icon on screen) that provides a manual on-off function (606) so that the light source of the image emitting device is turned on or off manually (via the App) to effectively form a wave to an oncoming vehicle. A second function may include a notification preference button (621). For example, the notification preference allows a user to select if they would like to be notified (620) or not (618). If the user selects to be notified (619), this function allows the phone to notify the user when in close proximity to a friend's phone using, for example, GPS signals. Notification may include the control device generating a visual image or sound, such as a chime sound, from the phone.

App 600 may also allow the user to upload their contacts from their social media accounts (607) on different platforms, such as Platform A (608) or B (609), e.g., Facebook or Instagram.

App 600 may also be configured to allow a user to upload images (624) from their gallery (625) or take a photo using a camera (626) and upload it to the controller or memory of the image emitting device to use as the back-lit image to wave with.

App 600 may include a location preference function—for example, this function when selected via a button (610) allows the user to choose (611) to opt in (612) or out of allowing (613) GPS tracking of their remote control device (as noted a handheld device, such as a phone or a tablet). phone

Another function may include selection of a wave preference (617). When selected, the user can choose (616) between a manual wave (614) or select a proximity auto wave function (615), where when the remote control device generates an automatic wave (615) based on proximity to a friend's phone GPS signal. Although described in reference to the user's control device sensing the proximity, a GPS sensor to detect a friend's GPS sign could be located and mounted in the vehicle, for example, including in the image emitting device. Alternately, the remote control device generates an automatic wave based on proximity to another image emitting device it detects based on a sensor, such as a proximity sensor, detecting the other image emitting device's presence.

While several forms of the invention have been shown and described in reference to vehicles, the image emitting device may be used in other settings, as noted, such as in marine and other settings. It should be understood that changes and modifications may be made to the specifically described embodiments without departing from the principles of the present invention, which is intended to be limited only by the scope of the appended claims, as interpreted according to the principles of patent law including the doctrine of equivalents.

I claim:

1. An image emitting device for use with a vehicle, said image emitting device comprising:
a plate with a plurality of regions arranged in a pattern to form an image, said plate having a first side forming a light emitting side and a second side forming a light input side;
a light source directing light into said light input side of said plate when powered; and
a power circuit to selectively power said light source based on (1) user input or (2) based on proximity to another driver or another image emitting device.

2. The image emitting device of claim 1, wherein said regions comprise openings through said plate.

3. The image emitting device of claim 1, further comprising a cover over said plate at said light emitting side wherein said cover is configured to hide or obscure said regions wherein said image is not viewable unless powered and light is emitted from said regions.

4. The image emitting device of claim 1, wherein said image emitting device is configured to mount to a forward-facing location of the vehicle.

5. The image emitting device of claim 1, wherein said light source comprises a plurality of light emitting diodes or an LCD screen.

6. The image emitting device of claim 1, further comprising a device housing, said device housing having an opening facing forward when mounted to a vehicle, and said plate mounted in said opening.

7. The image emitting device of claim 6, wherein said device housing has a cavity behind said plate, and said power circuit located in said cavity.

8. The image emitting device of claim 1, wherein said plate is removable and replaceable with a plate having a plurality of regions arranged in a second pattern to form another image.

9. An image emitting device for use with a vehicle, said image emitting device comprising:
a plate with a plurality of regions arranged in a pattern to form an image, said plate having a first side forming a light emitting side and a second side forming a light input side;
a light source directing light into said light input side of said plate when powered; and
a cover over said plate at said light emitting side wherein said cover is configured to hide or obscure said regions wherein said image is not viewable unless said light source is powered and light is emitted from said regions.

10. The image emitting device of claim 9, wherein said regions comprise openings through said plate.

11. The image emitting device of claim 9, further comprising a device housing configured to mount to a side view mirror assembly, and wherein said plate is mounted in said device housing.

12. The image emitting device of claim 11, further comprising a controller in said device housing to selectively power said light source.

13. The image emitting device of claim 11, wherein said regions comprise openings through said plate.

14. The image emitting device of claim 13, further comprising at least one diffuser between said plate and said light source wherein the light emitted from the light source is displayed uniformly across said openings.

15. An image emitting device for use with a vehicle, said image emitting device comprising:
a device housing configured to mount an exterior of the vehicle;
a plate with a plurality of regions arranged in a pattern to form an image, said plate having a first side forming a light emitting side and a second side forming a light input side, said plate mounted in said device housing wherein said light emitting side is forward facing when mount to the vehicle;
a light source in said device housing directing light into said light input side of said plate when powered; and
a controller in said device housing to selectively power said light source based on proximity to another driver or another image emitting device.

16. The image emitting device of claim 13, wherein said controller includes a timer circuit wherein said light source is powered for a predetermined or a selected duration of time.

17. The image emitting device of claim 13, wherein said device housing configured to mount to a side view mirror assembly.

18. The image emitting device of claim 10, further comprising a cover over said plate at said light emitting side wherein said cover is configured to hide or obscure said regions wherein said image is not viewable unless said light source is powered and light is emitted from said regions.

19. The image emitting device of claim 18, wherein said cover comprises a film.

20. The image emitting device of claim 18, wherein said cover comprises a lens.
